(19) United States
(12) Patent Application Publication
(10) Pub. No.: US 2010/0090805 A1
(43) Pub. Date: Apr. 15, 2010

(54) ELECTRONIC DEVICE AND MANAGEMENT OF COMPETING CONTACTLESS COMMUNICATION OF SUCH A DEVICE AND A HOST EQUIPMENT

(75) Inventor: Fabrice LlBOTTE, Issy Les Moulineaux (FR)

Correspondence Address: YOUNG & THOMPSON, 209 Madison Street, Suite 500, Alexandria, VA, 22314, US

(73) Assignee: OBERTHUR TECHNOLOGIES, Levallois-Perret (FR)

(21) Appl. No.: 12/572,713

(22) Filed: Oct. 2, 2009

(30) Foreign Application Priority Data
Oct. 2, 2008 (FR) 0856682

(51) Int. Cl. G06K 7/01; G06K 19/067

(52) U.S. Cl. 340/10.2; 235/492; 455/41.1

(57) ABSTRACT

An electronic device provided with RFID or NFC type short range contactless communication element, and a method of managing such element. The electronic device includes in particular a processing unit and first contactless communication element enabling the processing unit to communicate with a first external equipment, and includes in particular:
connection elements adapted to be connected to a second external equipment, and
elements for inhibiting the first contactless communication element when the connection elements interact with external contactless communication elements incorporated into the second equipment. The device applies to contactless smart cards used in mobile telephones.

This application claims priority from French patent application Ser. No. 08/56682 filed on Oct. 2, 2008, the entire contents of which are incorporated in the disclosure of the present application.

The present invention concerns an electronic device provided with contactless communication means and a method of managing such means. The invention applies in particular to contactless smart cards implementing the radio frequency identification (RFID) technology, for example in accordance with the near field communication (NFC) standard.

Smart cards, which are examples of portable electronic entities, conventionally communicate with an external equipment via a communication interface using electrical contacts C1-C8 according to the ISO/IEC 7816 standard.

To reduce the manipulations necessary for the use of these electrical contacts, cards provided with contactless (or wireless) communication interfaces, mainly using the RFID technology, have been developed. The ISO/IEC 14443 standard has been drawn up to define such interfaces and now applies to near field communications (NFC).

Thus there is known from the document WO 2008/028841 a dual interface smart card provided with both conventional power supply electrical contacts and communication electrical contacts and an additional contactless communication interface. This latter interface can in particular consist of a controller on the integrated circuit module of the card and an antenna integrated into the body of the card and connected to the controller.

The contact interface is provided for communicating with the host equipment physically receiving the card and the contactless interface enables communication with another equipment near the card.

Also known are smart cards, for example mobile telephone subscriber identity module (SIM) cards, that exploit contactless communication interfaces of the equipment that incorporates them, here telephones. These cards have only an interface via electrical contacts but are compatible with the NFC or equivalent format and use the NFC type contactless circuit of the telephone to communicate with other nearby external equipment via the electrical contacts C1-C8, generally the contact C6 for the single wire protocol (SWP) or the contacts C4-C8 for other protocols.

However, in some configurations, a dual interface smart card is used in equipment also provided with an NFC type contactless circuit. This situation can generate conflict between circuits for the processor of the card, which can “see” more than one contactless communication circuit, and can also generate conflict between signals resulting from mutual (electromagnetic) interference between the contactless signals emitted by both interfaces, degrading contactless communication with external equipment. This conflict between interfaces is all the more serious if they use the same transmission frequency and the same communication protocol.

An object of the present invention is to solve the aforementioned problems with a view to enabling use of an electronic device provided with a contactless interface in a host equipment also provided with such an interface.

The present invention provides in particular an electronic device including, for example on a module, a processing unit and first contactless communication means enabling said processing unit to communicate with a first external equipment, characterized in that it includes:
connecting means adapted to be connected to a second external equipment, and
means for inhibiting said first contactless communication means when said connection means interact with external contactless communication means incorporated into said second equipment.

Thus, according to the invention, if the device can use the contactless communication means of a host equipment (to which it is connected), its own contactless interface is deactivated to the benefit of that of the host equipment. This prevents the two contactless interfaces operating at the same time. This results in contactless communication that is free of electromagnetic interference caused by the contactless interface of the device itself.

The contactless communication means are for example short range communication means (typically with a range less than 20 cm, for example less than 10 cm) as described hereinafter. They could nevertheless be other types of contactless communication means, for example those using an antenna in a GPS type geopositioning system.

The interaction can take the form of a simple physical connection or a communication activity circulating between the external means and the connection means, as described hereinafter.

In one embodiment of the invention, the inhibition means include routing means adapted, based on said inhibition state, to route communication signals between the processor unit and the first external equipment to said connection means and the connected external communication means or to said first communication means. In particular, these routing means can take the form of a switch. Thanks to this feature, the inhibition and communication management functions are effected conjointly in order to communicate via the appropriate contactless transmission interface.

According to one possible feature, said inhibition means are integrated into the first communication means.

Alternatively, said inhibition means can be external to said first communication means. This embodiment enables use of unmodified contactless communication interfaces, for example conventional NFC type contactless circuits.

In one embodiment, the processing unit includes determination means adapted to determine, from configuration data received from said second equipment, at least one indication representative of the presence or absence of contactless communication means in said second equipment, and to control said routing means as a function of said indication determined in this way. The transmission of configuration data by the second equipment, for example a mobile telephone incorporating the device in the form of an SIM card, can in particular be part of a process for identifying and initializing the device when it is switched on. Thanks to this feature, implementing the inhibition necessitates no additional processing.

Alternatively, it can include determination means adapted to listen to said connection means to sense at least one signal sent by connected external contactless communication means and to control said routing means as a function of said listening. The inhibition effected by these means thus reflects the real and physical presence of operational contactless communication means. A corollary of this configuration is that the external contactless communication means transmit a continuous or periodic signal representative of the activation of themselves on a line shared with said connection means in order for the determination means to be able to detect this signal.

This configuration can also be combined with the use of configuration data as described above. This is because listening enables monitoring the availability status of the external contactless interface as a function of time, and thus enables the inhibition and the routing means (switch) to be adapted (updated) accordingly.

In particular, listening can consist in receiving data sent by external communication means and if necessary analyzing it to determine the presence of a wireless communication protocol, for example.

In particular, the determination means adapted to perform this listening can be incorporated into said first contactless communication means.

According to one particular feature, routing means include a switch with three states adapted to connect the processing unit, the connection means and the first contactless communication means two by two according to said state. In particular, there can be provided a set of electrical contacts connected to a module, for example a module carrying the processing unit and the first contactless communication means, and adapted to be connected by contact to said external second equipment, and the switch can then assume a state connecting said connection means and the determination means when said module is supplied with electrical power via at least one of said contacts so that said determination means can monitor said connection means. This switching state in particular enables the determination means to listen efficiently to the connection channel to the external wireless communication means that are to be detected. In particular, this switching state is obtained when switching on the device, for example when switching on a telephone containing a SIM card of the invention. This state can also be repeated periodically (outside periods in which there is actually communication in transit via the switch) in order regularly to confirm the availability of the external wireless communication means. This detects in particular the switching off of the contactless communication means in the mobile telephone.

According to another particular feature, there can be provided a set of electrical contacts connected to a module, for example a module carrying the processing unit and the first contactless communication means, adapted to be connected by contact to said external second equipment, and the routing means can then assume, in the absence of an electrical power supply via said contact, a state connecting said processing unit and said first communication means. This configuration corresponds, for example to the situation of a mobile telephone that is switched off incorporating a device of the invention, here a dual interface SIM card. This feature ensures that the SIM card is operational via only its internal contactless circuits as soon as the host equipment is switched off.

In order to ensure an automatic return to this switching state, a switch acting as a router can have access to this state by default (i.e. in the absence of power supply).

In one embodiment, said processing unit and the first communication means communicate according to the single wire protocol (SWP).

In another embodiment said connection means include at least one electrical contact terminal. In particular, the electrical contact terminal can be an electrical contact terminal of the C6 type conforming to the ISO/IEC 7816 standard supporting the single wire protocol (SWP). In this configuration, data to be transmitted without contact is routed to the terminal C6 and in the SWP format to the external contactless communication means to which they are transmitted by contactless electromagnetic waves.

Alternatively, said at least one electrical contact terminal is an electrical contact terminal of C4 and C8 type conforming to the ISO/IEC 7816 standard supporting either the USB protocol or the S2C protocol. This configuration favors the high bit rate transmission of data to the external contactless communication means.

In a variant of the electrical contact embodiment, said connection means are adapted to provide a contactless connection with said external second equipment. This contactless connection is separate from those set up by the first contactless communication means and can be of inductive or capacitive type.

In one embodiment, the first communication means and the external communication means operate in accordance with the same protocol and at the same frequency.

According to one feature that can be envisaged, the processing unit and the first contactless communication means communicate with each other using the single wire protocol (SWP). In this configuration, a smart card type device can be used with an interface combining the ISO 7816 and SWP protocols provided for operation with an antenna only in the host equipment, in particular a mobile telephone.

In one embodiment, the first communication means and the external communication means operate in accordance with a short range contactless communication protocol. In particular, the first communication means and the external communication means can operate in accordance with the near field communication (NFC) protocol. According to one particular feature, said short range is less than one meter, in particular less than 30 cm.

In one embodiment of the invention, the device can be an integrated circuit card, for example a memory card or a smart card (notably a universal integrated circuit card (UICC)). A universal integrated circuit card can notably be a SIM card or a USIM (Universal SIM) card. In particular, said integrated circuit card is to the ID-000 format.

In one embodiment, said processing unit and the first communication means constitute a single electronic component mounted on said module. This component is generally mounted on the back of a support substrate constituting the module (the portion buried in a cavity in the smart card body). Alternatively, they can be mounted on a PVC layer carrying the antenna using the flip chip technique well known to the person skilled in the art.

In particular, the device can include an antenna connected to said first communication means and a body enclosing said antenna and provided with a cavity to receive said module.

The invention is also directed to a communication system including an electronic device as described hereinabove and host equipment provided with said external contactless communication means and adapted to incorporate said electronic device.

In a correlated way, the invention also relates to a communication management method for an electronic device including first contactless communication means for communicating with a first external equipment, the method including the following steps:
determining interaction between said electronic device and contactless communication means of a second equipment external to said device;
in the event of positive determination, inhibiting said first contactless communication means so that said device communicates with said first equipment via contactless communication means of the second equipment.

Such a method can where appropriate further include steps related to the optional features of the device described above.

Other particular features and advantages of the invention will become more apparent in the course of the following description, which is illustrated by the appended drawings, in which:

FIG. 1 is a top view showing one example of the disposition of an integrated circuit module and a loop antenna in a contactless smart card, as if the card were transparent;

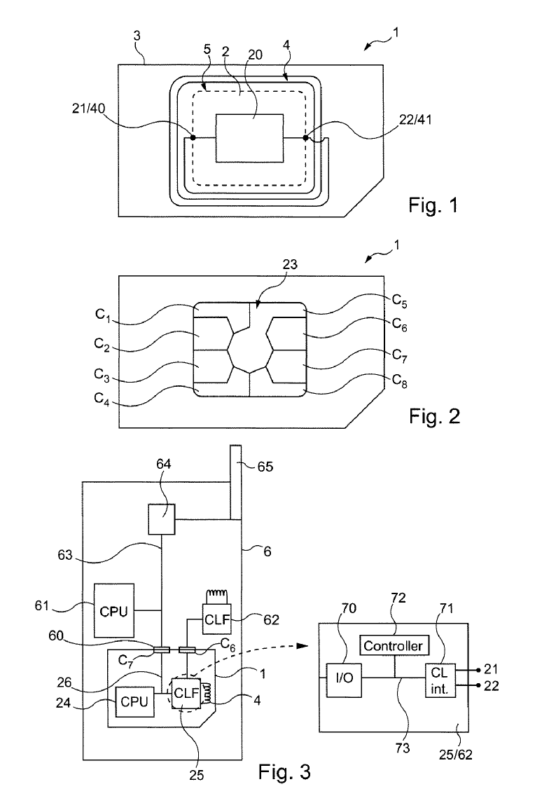

FIG. 2 is a top view of the FIG. 1 card showing its flush electrical contacts;

FIG. 3 represents diagrammatically a mobile telephone equipped with the smart card from the previous figures;

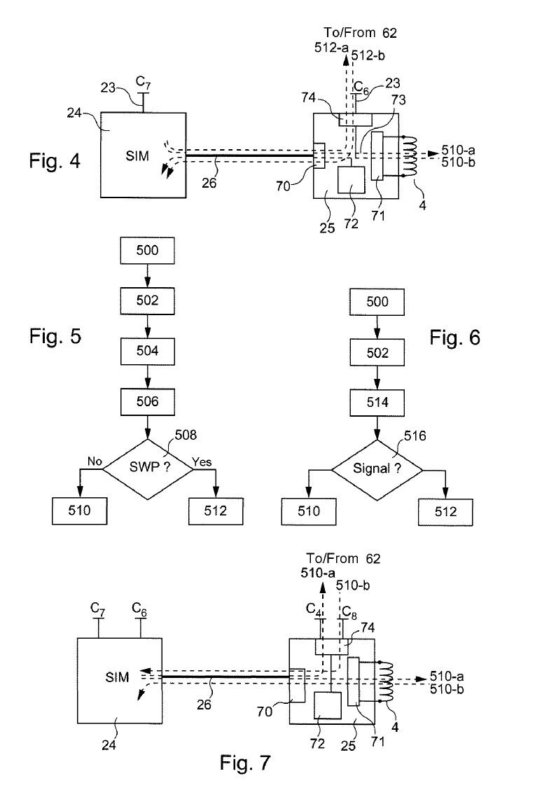

FIG. 4 is a functional block diagram illustrating a first embodiment of the invention;

FIG. 5 represents in flowchart form the steps of the method of the invention for a card conforming to the FIG. 4 example;

FIG. 6 represents in flowchart form the steps of a second example of a method of the invention;

FIG. 7 is a functional block diagram illustrating a second embodiment of the invention;

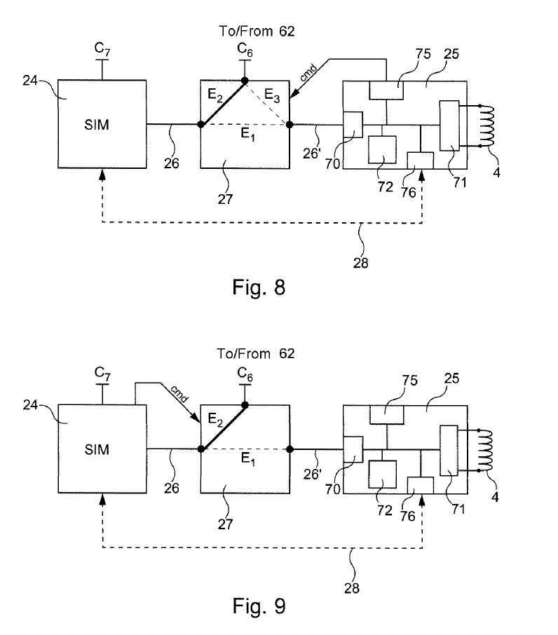

FIG. 8 is a functional block diagram illustrating a third embodiment of the invention; and

FIG. 9 is a functional block diagram illustrating a fourth embodiment of the invention.

The invention concerns an electronic device, notably of the portable or pocket type. For example, such a device can take the form of a smart card, a USB (Universal Serial Bus) key, or a memory card of the SD (Secure Digital) or MMC (Multimedia Memory Card) type.

As shown in FIG. 1, an electronic device 1, here a dual interface smart card, i.e. a card combining a contactless communication interface and an electrical contact communication interface, includes a flat flexible plastic body 3 of SIM card type to the ID-000 format and approximately 0.76 mm thick. The body 3 encloses in a cavity 5 a module 2 with an integrated circuit 20, in particular of the secure module type, and, within its thickness, an inductive antenna 4 adapted to exchange information and at the same time receive electrical energy necessary for the module 2 to function by electromagnetic coupling with an external reader device.

The antenna 4 is for example tuned to a frequency of approximately 13.56 MHz, according to the ISO 14443 standard, in particular of the short range NFC type, typically with a range of 1 to 3 decimeters, for example 20 cm. Its inductive part is formed of conductive turns, for example of photo-etched copper, carried by both sides of an insulative film usually called the inlay, sandwiched between two PVC, PET or other polymer films by hot lamination to produce the card body 3. The conductive turns of the antenna terminate in conductive lands 40, 41 attached to the same side of the insulative film thanks to an auxiliary bridge and positioned in the cavity 5.

The module 2 includes a support substrate carrying on its face facing toward the bottom of the cavity (i.e. its back) the integrated circuit or circuits 20, the antenna connection conductive lands 21, 22 facing those 40, 41 of the antenna.

As shown in FIG. 2, the substrate of the module 2 has on its face opposite the bottom of the cavity 5 a set of electrical contacts 23 flush with the surface of the card 1, accessible from outside the card 1 and disposed in accordance with the ISO 7816-2 standard, i.e. eight terminals C1-C8 also enabling connection by contact with a host equipment for the purposes of electrical power supply and communication (for example reading).

The contacts C1 and C5 supply electrical power to the module 2, the first being connected to Vcc and the second to ground.

Communication according to the ISO/IEC 7816 standard is effected via terminals C2, C3 and C7, respectively receiving a clock signal (CLK), a reset signal (RST) and an input-output signal (I/O).

The terminal C6, known as the programming voltage input, is dedicated here, in some embodiments, to communication with the host equipment using the single wire protocol (SWP). It is conventionally used by electrical contact microchips to communicate with NFC type contactless circuits of the host equipment.

The terminals C4 and C8 are generally unassigned. In one embodiment of the invention, these two terminals can be used for communication with the host equipment using the USB (Universal Serial Bus) or S2C (SigIn SigOut Connection) protocol.

FIG. 3 is a functional representation of the card 1 when it is incorporated into a host equipment 6, such as a mobile telephone.

The integrated circuits 20 include a SIM type processor (CPU) 24 performing the standard mobile telephone operations and a ContactLess Front end (CLF) management module 25 for managing contactless communications, preferably of NFC type. This CLF module 25 associated with the antenna 4 provided in the body of the card 1 constitutes an NFC type contactless circuit incorporating in particular microcomponents such as capacitors to perform the antenna tuning and biasing functions.

To manage communications, the NFC contactless circuit 25 also includes conversion means for converting the induced current produced by the antenna 4 (when the device is subjected to an electromagnetic field from an external equipment) into digital data sent to the processor 24, for example, and digital data received from the processor 24 into modulation of the load on the antenna circuit in order to send data to the external reader in the form of electromagnetic signals.

Data passing in transit through such a contactless interface 25 is referred to hereinafter as “contactless data”.

The separate integrated circuits 24, 25 are connected by a data bus 26 to a contact communication interface including contacts 23, for example the contact C7. Instead of the data bus, direct electrical connections between the various components can be used. The CLF management module 25 is directly connected to the contact C6 by an electrical wire.

Alternatively, the processor 24 and the management module 25 can be integrated into the same circuit 20.

The host equipment 6 includes a communication interface 60 corresponding to that of the contacts 23, a central processor unit 61 provided with standard mobile telephone software, an NFC type contactless CLF circuit 62, an interconnection data bus 63 and electrical power supply means (of the battery type, not shown) for these various components (this list is not exhaustive). The CLF circuit 62, functioning identically to the NFC circuit 25, is in particular connected only to a contact terminal facing the contact C6 of the card 1.

The equipment 6 also includes standard means for communicating via a mobile telephone network, here a microcontroller 64 and a GSM antenna 65. This equipment is preferably a mobile telephone.

When the host equipment 6 is switched on, it supplies power to the chip 1 at the contacts C1 and C5 and dialogs with the chip according to the ISO 7816 standard via the contacts C2, C3 and C7 (represented only by the contact C7 hereinafter for reasons of simplification).

A contactless CLF circuit 25, 62 includes an input/output interface 70 with the corresponding data bus 26, 63, a contactless data send/receive interface 71 associated with an antenna (here only the conductive lands 21 and 22 are shown in the case of the CLF module 25) and which in particular demodulates radio-frequency signals received at the antenna, a controller 72 and a data bus 73 interconnecting these various elements.

FIG. 4 represents a first example of the invention. Note that the invention concerns managing contactless data, the card 1 continuing to dialog with the host equipment 6 in the standard manner via the contact C7.

The SIM processor 24 is connected directly to the C7 type terminal 23 to dialog according to the ISO 7816 standard with the host telephone 6 when it is switched on.

The SIM processor 24 and the contactless CLF module communicate over the bus 26 using the single wire protocol. The serial peripheral interface (SPI) and ISO 7816 protocols can instead be used for this purpose.

The contactless module 25 is furthermore connected to the C6 type terminal 23 supporting the single wire protocol.

In operation, the telephone 6 is switched on in the step 500, as shown in FIG. 5. The SIM card 1 is switched on in turn via the contacts C1 and C5 in the step 502.

In the step 504, this switching on initializes communication between the SIM card 1 and the telephone 6 using the ISO 7816 protocol, mainly via the terminal C7.

This initialization procedure includes, in the step 506, the telephone 6 sending the processor 24 of the card 1, a configuration file in APDU command form known as a terminal profile. This file is specified by the ETSI TS 102.223 standard and in particular provides the processor 24 with all the instructions supported by the telephone 6, for example SWP instructions. Bit b5 of the thirtieth byte of the terminal profile is used for this purpose, for example.

Alternatively the “TERMINAL CAPABILITY” command of the ETSI TS 102.221 standard could be used, in particular enabling the telephone to indicate to the processor 24 of the card 1 the presence of a CLF module (bit b1 of the TLV object labeled 82).

In the step 508, the processor 24 determines from this terminal profile file if the telephone 6 supports the single wire protocol or more generally detects any information for identifying if the telephone 6 is provided with NFC type contactless communication means that the SIM card 1 can access via the contact C6.

If not, in the step 510, the SIM processor 24 commands the CLF management module 25 to use the internal contactless interface, i.e. that via the antenna 4. This is the standard default state of the SIM card 1.

This situation corresponds to standard operation of the contactless interface of a dual interface card: contactless signals generated by the processor 24 are received via the bus 26 by the management module 25 which transmits them in the form of electromagnetic signals via the antenna 4 (arrow 510-a). As far as reception is concerned, signals received via this antenna 4 and digitized in the management module 25 are sent to the SIM processor 24 for processing (arrow 510-b) via the bus 26.

To control the management module 25, the processor 24 can send the controller 72, a bit (or flag) representing the result of the step 508, i.e. indicating if the telephone 6 has its own contactless communication means, here of NFC type. Given this bit, the controller 72 then ensures that messages received via the interface 70 are forwarded to the interface 71.

In the event of a positive determination in the step 508, i.e. if interaction between the terminal C6 and the CLF circuit 62 is effected via a single electrical contact, the SIM processor 24 commands the CLF management module 25 in the step 512 thereafter to route contactless signals to the C6 type contact 23 used to transmit SWP signals from the card 1 to the NFC type contactless circuits 62 of the host telephone 6.

At this stage, the controller 72 routes incoming signals at the interface 70 to the interface 74 provided at the level of the contact C6 (contactless transmission of data using the contactless communication means specific to the telephone—arrow 512-a) and incoming signals at the interface 74 to the interface 70 (reception of contactless data—arrow 512-b).

Once again, the flag representing the result of the step 508 is used by the controller 72 to perform this function of routing signals in the management module 25.

The card 1 and the telephone 6 are thus configured to transmit and receive contactless data efficiently without interference, either via the NFC interface 25 if the telephone has no such NFC interface or via the NFC interface 62 if the telephone has one and is switched on.

In a variant illustrated by FIG. 6, the NFC contactless circuit 62 of the telephone 6 sends an activity signal continuously at the C6 contact 23 to which it is connected, for example receiving electrical power from the telephone 6 or obtained from the electromagnetic coupling of the NFC circuit 62 and an external reader (not shown). This signal conforms to the ETSI TS 102-613 standard.

After the telephone 6 is switched on (step 500) and the SIM card 1 is switched on (step 502), the CLF management module 25 starts to listen to the communication channel C6 in the step 514. This listening can continue for a predetermined time, for example ten seconds.

At the end of this time, in the step 516, the controller 72 determines if an activity signal has been sensed at the contact C6. If a signal has been sensed, the next step is the step 512. If not, the next step is the step 510.

If the NFC interface 62 is de-activated, for example by means of a menu in the telephone, the invention detects this deactivation efficiently and switches to the NFC interface 25 internal to the card 1; while the NFC circuit 62 may remain physically connected to the terminal C6.

If no contactless transmission or reception of data is in progress, the step 514 can be repeated periodically, for example every five minutes, in order to detect deactivation/activation of the NFC interface 62, for example on entering/leaving the electromagnetic field of an external reader. This feature can complement that based on the use of the terminal profile file.

In a similar way, when the SIM card 1 is switched off (for example on switching off the telephone 6), the controller 72 goes automatically to a “SIM antenna” state similar to that of the step 510. This automatic change can in particular be triggered through a data bit (or flag) stored in random-access memory and representing the result of the step 508 or 516. Thus switching off the card 1 erases this bit, which the controller 72 interprets as absence of the NFC circuit 62. By default, the controller 72 is in the “SIM antenna” state.

FIG. 7 represents a second embodiment of the invention which differs from that of FIG. 4 in the assignment of the contacts C1-C8. Here the contacts C6 and C7 are connected directly to the SIM processor 24 and the contacts C4 and C8 are connected to the management module 25.

In this example, the telephone 6 makes its contactless interface 62 available to an integrated smart card 1 and to this end communicates with the latter card via the electrical contacts C4 and C8 using the USB protocol. The telephone 6 and the card 1 continue to be able to communicate via the contact C7 using the ISO 7816 protocol.

The card 1 can detect the presence of an NFC contactless interface in the telephone 6 via the terminal profile file, as described above and/or by monitoring the USB channel at the contacts C4 and C8.

The various steps of FIGS. 5 and 6 therefore apply to this embodiment.

FIG. 8 shows a third embodiment of the invention.

This embodiment incorporates a three-state switch 27 as an interface between the SIM processor 24 and the management module 25. The third input of the switch is the contact C6.

In a default first state E1 of the switch 27, the SIM processor 24 is connected to the management module 25 (at the interface 70).

In a second state E2 (as represented in the figure), the SIM processor 24 is connected to the C6 type terminal 23.

In the third state E3, the interface 70 of the module 25 is connected to the terminal C6.

In the absence of electrical power supply to the card 1 via the contacts C1 and C5 (i.e. if the card is not incorporated in a host equipment C6 or the latter equipment is switched off), the switch 27 is in the default state E1, which enables standard autonomous use of the dual interface card. This is the case in particular if the telephone 6 is switched off and the card 1 is in the field of a reader that supplies it with power by electromagnetic coupling.

As soon as the card 1 is switched on via the contacts C1 and C5, the switch 27 goes automatically to the state E3 enabling the controller 72 to monitor the contact C6. An activity signal is sensed by the management module 25 as described above (listening period, periodicity, etc.).

As a function of this sensing, the controller 72 sends a command signal via an interface 75 to the switch 27 so as to switch it into the state E1 (if no activity signal has been sensed) or the state E2 (if such a signal has been sensed).

The SIM processor 24 is then connected either to the internal NFC circuit 25+4 or to the NFC circuit 62 of the telephone for contactless transmission and reception of data.

In a variant that is not shown, the switch is a two-state switch with states corresponding to the above states E1 and E2. To determine if the host terminal 6 includes an NFC circuit 62, the SIM processor 24 listens to the terminal C6 when the switch is set initially to the state E2 or analyzes a terminal profile file received at the contact C7. The information relating to the detection of an activity signal or to the presence of an NFC circuit 62 is sent to the controller 72 via a serial link 28 between the processor 24 and the management module 25. The controller 72 then controls the switch 27 as a function of the information received.

The serial connection 28 here enables the processor to deactivate the management module 25 if the host terminal 6, here the telephone, includes the NFC contactless communication means 62.

FIG. 9 shows a fourth embodiment, similar to that from FIG. 8, except that the switch 27 is controlled by the SIM processor 24.

A switch is shown here with only two states E1-E2 because, in this embodiment, the NFC circuit 62 is detected by the SIM processor 24 via the terminal profile file or by listening to the contact C6 if the switch 27 is in the state E2.

As a function of the result of this detection, the SIM processor 24 sends a control signal to the switch 27 causing it to switch to the state E1 if no NFC circuit 62 has been detected or to the state E2 if an NFC circuit 62 has been detected.

This embodiment uses existing internal NFC circuits since no modification of them is necessary to implement the invention.

It is to be understood that the third and fourth embodiments can be combined in particular to offer an architecture in which the SIM processor 24 controls a three-state switch 27, the management module 25 listening to the contact C6 and sending detection information via the serial link 28.

Accordingly, the card 1 of the present invention can be used in mobile telephones 6 with no contactless communication means, in mobile telephones that have such means, in which case the card enables the contactless communication means to not interfere with each other, which would prevent efficient communication, and on its own, outside the telephone, in particular communicating via its internal NFC type contactless interface.

The foregoing embodiments are merely examples of the invention, which is not limited to them.

In particular, it does not matter whether the contact C6, the contacts C4 and C8, new flush electrical contacts not covered by the ISO 7816 standard (and thus different the contacts from C1-C8) or contactless connection points, for example of capacitive or inductive type, is or are used to communicate contactless data with the host equipment 6.

Similarly, the routing function implemented by the controller 72 in the first two embodiments described above can be replaced by an internal switch (with two or three states) controlled by the same controller 72 that connects the interface 70 to one of the two interfaces 71 and 74 depending on the required inhibition state.

Although in the foregoing embodiments the NFC circuit 62 is dissociated from the other components of the telephone 6, this circuit 62 can be connected to the common bus 63. Furthermore, communication between this circuit 62 and the smart card 1 can pass in transit via the CPU processor 61.

A power saving function enables the SIM processor to deactivate the internal NFC type contactless circuit 25 (or to put it on standby) in order to prevent contactless communication or to save power. This power saving function can thus be used to inhibit the NFC circuit 25 if the SIM processor 24 detects the presence of an NFC contactless circuit 62 in the host equipment 6.

Although the device 1 using the NFC circuit 25 and the device 1 using the NFC circuit 62 are described above in a passive operating mode in which an external contactless reader supplies power to the respective NFC circuits, the invention applies equally to the case where these circuits 25 and 62 operate in active mode according to the NFC standard, i.e. when they themselves constitute a short range contactless reader.

The inhibition of the contactless module 25 described above naturally does not rule out the possibility of the user deactivating this module, for example via a menu of the telephone, by modifying a data item stored in the card 1 and determining the activated/deactivated state of the contactless module 25.

1. Electronic device including a processing unit and first contactless communication means enabling said processing unit to communicate with a first external equipment, characterized in that it includes:
connecting means adapted to be connected to a second external equipment, and
means for inhibiting said first contactless communication means when said connection means interact with external contactless communication means incorporated into said second equipment.

2. Device according to claim 1, wherein said inhibition means include routing means adapted, based on said inhibition state, to route communication signals between the processor unit and the first external equipment to said connection means and the connected external communication means or to said first communication means.

3. Device according to claim 2, wherein said inhibition means are integrated into the first communication means.

4. Device according to claim 2, wherein said inhibition means are external to said first communication means.

5. Device according to claim 2, wherein the processing unit includes determination means adapted to determine, from configuration data received from said second equipment, at least one indication representative of the presence or absence of contactless communication means in said second equipment, and to control said routing means as a function of said indication determined in this way.

6. Device according to claim 2, including determination means adapted to listen to said connection means to sense at least one signal sent by connected external contactless communication means and to control said routing means as a function of said listening.

7. Device according to claim 6, wherein said determination means adapted to perform said listening are integrated into said first contactless communication means.

8. Device according to claim 7, wherein said routing means include a switch with three states adapted to connect the processing unit, the connection means and the first contactless communication means two by two according to said state.

9. Device according to claim 8, including a set of electrical contacts connected to a module and adapted to be connected by contact to said second external equipment and wherein said switch assumes a state connecting said connection means and the determination means when said module is supplied with electrical power via at least one contact of said contact so that said determination means listen to said connection means.

10. Device according to claim 2, including a set of electrical contacts connected to a module and adapted to be connected by contact to said second external equipment and wherein, in the absence of electrical power supply via said contact, said routing means assume a state connecting said processing unit and said first communication means.

11. Device according to claim 1, wherein said connection means include at least one electrical contact terminal.

12. Device according to claim 11, wherein said electrical contact terminal includes a C6 type electrical contact terminal conforming to the ISO/IEC 7816 standard supporting the single wire protocol (SWP).

13. Device according to claim 1, wherein the first communication means and the external communication means operate using the same protocol and at the same frequency.

14. Device according to claim 1, wherein the processing unit and the first contactless communication means communicate with each other using the single wire protocol (SWP).

15. Device according to claim 1 wherein the first communication means and the external communication means use the near field communication (NFC) protocol.

16. Device according to claim 1, characterized in that the device is a universal integrated circuit card (UICC).

17. Method of managing communication of an electronic device including first contactless communication means for communicating with a first external equipment, the method including the following steps:
determining interaction between said electronic device and contactless communication means of a second equipment external to said device;
in the event of positive determination, inhibiting said first contactless communication means so that said device communicates with said first equipment via contactless communication means of the second equipment.

18. Device according to claim 2, including a set of electrical contacts connected to a module and adapted to be connected by contact to said second external equipment and wherein said switch assumes a state connecting said connection means and the determination means when said module is supplied with electrical power via at least one contact of said contact so that said determination means listen to said connection means.

19. Device according to claim 3, wherein the processing unit includes determination means adapted to determine, from configuration data received from said second equipment, at least one indication representative of the presence or absence of contactless communication means in said second equipment, and to control said routing means as a function of said indication determined in this way.

20. Device according to claim 4, wherein the processing unit includes determination means adapted to determine, from configuration data received from said second equipment, at least one indication representative of the presence or absence of contactless communication means in said second equipment, and to control said routing means as a function of said indication determined in this way.
